(19) United States
(12) Patent Application Publication
(10) Pub. No.: US 2023/0239969 A1
(43) Pub. Date: Jul. 27, 2023

(54) ELECTRIC HEATING SYSTEM AND HEATING METHOD CAPABLE OF ADAPTING TO VARIOUS VOLTAGES

(71) Applicant: SUZHOU JERNANO CARBON CO., LTD., Suzhou, Jiangsu (CN)

(72) Inventors: Qunzhen YANG, Suzhou (CN); Li ZENG, Suzhou (CN); Wei LYU, Suzhou (CN)

(21) Appl. No.: 18/002,406

(22) PCT Filed: Oct. 11, 2021
(86) PCT No.: PCT/CN2021/122984

§ 371 Date: Dec. 19, 2022

(30) Foreign Application Priority Data
Dec. 3, 2020 (CN) 202011405111.2

(51) Int. Cl. H05B 1/02

(52) U.S. Cl. CPC H05B 1/0272; H05B 2203/013; H05B 2203/007

(57) ABSTRACT

Electric heating system and heating method capable of adapting to various voltages are provided. The electric heating system includes: multiple heating elements, a controller, a variable-frequency charging element and at least one electric connector. The controller is electrically connected to the multiple heating elements arranged in parallel. The controller is electrically connected to the at least one electric connector through the variable-frequency charging element, allowing the electric connector to connect to power sources with different rated powers and delivers electricity to the multiple heating elements according to preset power-on logic. By adopting specific heating logic, the electric heating system and the heating method are applicable to various types of voltage inputs, independent temperature control for multiple pads is available, and adaption to all types of external power sources is enabled so as to ensure that 10 W, 18 W and 40 W external power sources can all operate at respective rated powers.

### CROSS REFERENCE TO RELATED APPLICATIONS

This application is a U.S. National Stage Application, filed under 35 U.S.C. 371, of International Patent Application No. PCT/CN2021/122984, filed on Oct. 11, 2021, which claims priority to Chinese Patent Application No. 202011405111.2, filed with CNIPA on Dec. 3, 2020, entitled as “ELECTRIC HEATING SYSTEM AND HEATING METHOD CAPABLE OF ADAPTING TO VARIOUS VOLTAGES”, the entire contents of which are incorporated herein in their entireties.

### TECHNICAL FIELD

The present disclosure relates to the technical field of electric heating. The present disclosure relates to an electronic heating system, and more particularly relates to an electric heating system capable of adapting to various voltages and a heating method capable of adapting to various voltages.

### BACKGROUND

With the widespread popularity of smart heating clothing products on the market, user demand for warming speed and heating area is increasing. Nevertheless, rated voltage and rated current output of a conventional power bank currently on the market is 5 V/2 A. Due to the limitation of power output capacity of the power source for the heating system, the heating area and the warming speed of the heating system cannot satisfy consumer requirements for heating experience.

### SUMMARY

The present disclosure provides an electric heating system and a heating method capable of adapting to various voltages to overcome the deficiencies in the relevant technology.

The technical solution provided by the present disclosure is as follows.

An electric heating system capable of adapting to various voltages is provided according to an embodiment of the present disclosure. The system includes: multiple heating elements, a controller, and at least one electric connector. The controller is electrically connected to the multiple heating elements, the multiple heating elements are arranged in parallel. The controller is electrically connected to at least one electric connector. When an electric connector is connected to an external power source, the controller enables, according to preset power-on logic, the external power source to distribute power to the multiple heating elements, preventing an output power of the external power source from exceeding the rated power of the external power source.

An electric heating method capable of adapting to various voltages is also provided according to an embodiment of the present disclosure. The method may include: providing the electric heating system capable of adapting to various voltages and connecting the electric connector electrically to an external power source; supplying electricity and distributing power to the multiple heating elements according to a preset power-on logic at least based on at least one of an amount of a rated power of the external power source or an area of each heating element, such that each heating element generates heat independently and an output power of the external power source does not exceed the rated power of the external power source.

### BRIEF DESCRIPTION OF THE DRAWINGS

FIG. 1 is a schematic structural diagram of an electric heating system capable of adapting to various voltages according to an embodiment of the present disclosure;

FIG. 2 schematically illustrates a power-on logic of an electric heating system capable of adapting to various voltages according to an embodiment of the present disclosure;

FIG. 3 schematically illustrates a power-on logic of an electric heating system capable of adapting to various voltages according to another embodiment of the present disclosure;

FIG. 4 schematically illustrates a power-on logic of an electric heating system capable of adapting to various voltages according to still another embodiment of the present disclosure; and

FIG. 5 schematically illustrates a power-on logic of an electric heating system capable of adapting to various voltages according to further another embodiment of the present disclosure.

### DETAILED DESCRIPTION OF THE EMBODIMENTS

Inventors of the present application have devoted extensive studies and practices to provide technical solution of the present disclosure. The technical solution and implementation and principle thereof are further explained as follows.

An electric heating system and a heating method capable of adapting to various voltages are provided according to embodiments of the present disclosure. Through fast charge invoking technique, 20 V/2 A or 9 V/2 A high-voltage rated output of an external power source is invoked to perform heating, thereby achieving fast warming and large-area heating. Furthermore, a specific heating logic in the present disclosure is compatible with a 5 V/2 A power supply system on the market.

An electric heating system capable of adapting to various voltages is provided according to an embodiment of the present disclosure, which may include multiple heating elements, a controller and at least one electric connector. The controller is electrically connected to the multiple heating elements, and the multiple heating elements are arranged in parallel. The controller may be electrically connected to at least one electric connector. When an electric connector is connected to an external power source, the controller enables, according to preset power-on logic, the external power source to distribute power to the multiple heating elements, preventing an output power of the external power source from exceeding the rated power of the external power source.

Optionally, each of the multiple heating elements may be electrically connected to the controller independently, and may independently generate heat under the control of the controller.

Optionally, at least one of heating temperature or heating time of the multiple heating elements may be identical or different.

Optionally, the controller may include a fast charge protocol chip, a single-chip microcomputer and multiple control circuit modules. The single-chip microcomputer is connected to the fast charge protocol chip and is connected to the multiple control circuit modules respectively. The multiple control circuit modules are connected to the multiple heating elements respectively.

Optionally, the multiple control circuit modules may be configured to independently control current or voltage outputs of the multiple heating elements, and the multiple heating elements may be configured to feed temperature back to the single-chip microcontroller.

Optionally, the electric heating system capable of adapting to various voltages may include multiple heating units. The controller may be connected to the multiple heating units respectively, where each heating unit may include one or more heating elements.

Optionally, the heating element may include an electrothermal film.

Optionally, the electric heating system capable of adapting to various voltages may include multiple electric connectors. The electric connectors may include a USB connector.

Optionally, the electric heating system capable of adapting to various voltages may further include multiple temperature sensors. The multiple temperature sensors may be connected to the multiple heating elements respectively, and may each be connected to the controller.

An electric heating method capable of adapting to various voltages is further provided according to an embodiment of the present disclosure, which includes:

providing the electric heating system capable of adapting to various voltages, and connecting the electric connector electrically to an external power source;

supplying electricity and distributing power to the multiple heating elements according to a preset power-on logic at least based on an amount of rated power of the external power source and/or an area of each heating element, such that each heating element generates heat independently, and an output power of the external power source does not exceed the rated power of the external power source.

Optionally, the electric heating method capable of adapting to various voltages may include: successively and periodically supplying electricity to the multiple heating elements to enable the multiple heating elements to generate heat successively and periodically; or, simultaneously supplying electricity to the multiple heating elements to enable the multiple heating elements to generate heat simultaneously, where electricity may be supplied to the multiple heating elements at identical time or at different time.

Optionally, a sum of currents flowing through the multiple heating elements does not exceed a rated current of the power source.

Optionally, the rated current of the power source is 2 A, and a rated voltage of the power source is 5-20 V.

In some specific implementations, in case that the voltage of the external power source is 20 V, a proportion of a heating duration of a respective heating element to one electricity supplying period is to =Sₙ/(S₁+S₂ . . . +Sₙ), a heating power of a respective heating element is: Wₙ=Pₙ×tₙ=U²×tₙ/Rₙ. Here, n is the quantity of heating elements, n is greater than or equal to 2, Sₙ is an area of the heating element, Wₙ is the heating power of the heating element, Pₙ is a rated power of the heating element, Rₙ is a resistance of the heating element.

In some specific implementations, in case that the voltage of the external power source is 9 V, a proportion of a heating duration of a respective heating element to one electricity supplying period is to =(2×Sₙ)/(S₁+S₂ . . . +Sₙ), a heating power of a respective heating element is: Wₙ=Pₙ×tₙ=U²×tₙ/Rₙ. Here, n is the quantity of heating elements, n is greater than or equal to 2, Sₙ is the area of the heating element, Wₙ is the heating power of the heating element, Pₙ is a rated power of the heating element, Rₙ is a resistance of the heating element.

In some specific implementations, in case that the voltage of the external power source is 5 V, a proportion of a heating duration of a respective heating element to one electricity supplying period is to =1, a heating power of a respective heating element is: Wₙ=Pₙ×tₙ=U²×tₙ/Rₙ. Here, n is the number of heating elements, n is greater than or equal to 2, Sₙ is an area of the heating element, Wₙ is the heating power of the heating element, Pₙ is a rated power of the heating element, Rₙ is a resistance of the heating element.

Hereinafter the technical solution, and implementation and principle thereof are optionally described in detail in conjunction with the drawings and embodiments.

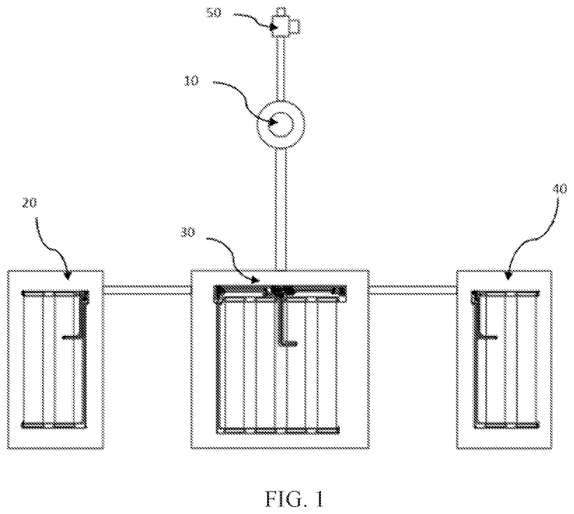

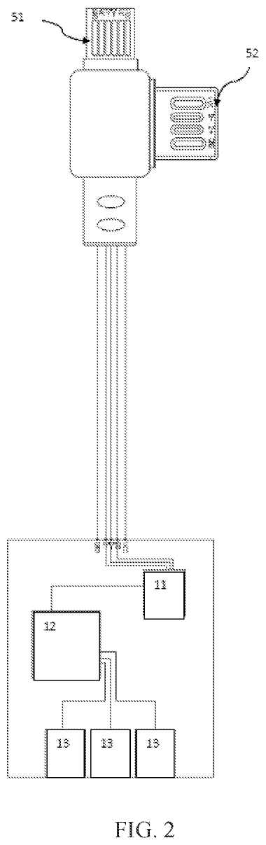

Referring to FIG. 1 and FIG. 2, an electric heating system capable of adapting to various voltages includes three heating elements 20, 30, 40, a controller 10 and an electric connector 50. The controller 10 is connected to the three heating elements 20, 30 and 40 respectively and the three heating elements 20, 30 and 40 are arranged in parallel.

In addition, the controller 10 may be connected to the electric connector 50. When the electric connector 50 is connected to an external power source, the controller 10 may enable, according to preset power-on logic, the external power source to distribute power to the three heating elements 20, 30 and 40, such that an output power of the external power source does not exceed a rated power of the external power source. Each of the three heating elements 20, 30 and 40 may be independently electrically connected to the controller 10, and may independently generate heat under the control of the controller 10.

Specifically, the heating elements 20, 30, 40 may include electrothermal films, the electric connector 50 includes a USB interface 51 and a Type-C interface 52.

Specifically, the controller 10 may include: a fast charge protocol chip 11, a single-chip microcomputer 12 and three control circuit modules 13. The single-chip microcomputer 12 is connected to the fast charge protocol chip 11 and each of the three control circuit modules 13. The three control circuit modules 13 are respectively connected to the three heating elements 20, 30 and 40.

Specifically, the single-chip microcomputer 12 in the controller 10 communicates with the external power source through the fast charge protocol chip 11 and via D+, D− signal pins of the USB interface 51 or a configuration channel (CC) pin of the Type-C interface 52. According to the standard communication protocol PD 2.0 in the fast charge industry, the USB interface 51 enables a power bank to output 9 V/5 V voltage for heating elements to generate heat. According to a CC interface communication protocol, the Type-C interface 52 may enable a power bank to output 20 V/9 V/5 V voltage for heating elements to generate heat. Meanwhile, multiple heating control circuit modules 13, configured internally within the controller 10, may independently control the voltage or current output to respective heating elements, and each heating element feeds back a temperature to the single-chip microcomputer, thereby achieving independent temperature control for each heating element. In addition, the heating element is heated according to a specific heating logic, which achieves excellent heating experience at 20 V, great heating experience at 9 V and good heating experience at 5 V.

Specifically, the electric heating system capable of adapting to various voltages may further include: multiple temperature sensors. The multiple temperature sensors are connected to the multiple heating elements respectively, and each are connected to the controller.

An electric heating system capable of adapting to various voltages is provided according to an embodiment of the present disclosure, which supports PD 3.0 fast charging function. Conventional power bank on the market supports Type-A output and Type-C interface output. If a power bank supports fast charging function, using the electric heating system capable of adapting to various voltages shown in FIG. 1, a 20 V&9 V&5 V power source may supply electricity to the heating system via a Type-C electric connector, and a 9 V/5 V power source may supply electricity to the heating system via a Type-A electric connector (namely the foregoing USB interface).

The rated current is always 2 A when the conventional power bank outputs voltage of 20 V or 9 V or 5 V Hence, the resistances of the heating elements 20, 30, 40 need to be controlled during design to guarantee that an output current of the power bank does not exceed 2 A while fully utilizing the power of the power bank. Otherwise, it may damage the power bank or cause other harmful phenomena.

In some specific implementations, in case that the voltage of the external power source is 20 V, a proportion of a heating duration of a respective heating element to one electricity supplying period is to =Sₙ/(S₁+S₂ . . . +Sₙ), a heating power of a respective heating element is:

$${W}_{n} = {P}_{n} \times {t}_{n} = {U}^{2} \times \frac{{t}_{n}}{{R}_{n}} = {20}^{2} \times \frac{{t}_{n}}{10} = 40 {t}_{n} ;$$

a total heating power of multiple heating elements can be obtained by:

$$\sum w = {W}_{1} + {W}_{2} + {W}_{3} + … + {W}_{n} = 40 \times \frac{{S}_{1} + {S}_{2} + {S}_{3} + … + {S}_{n}}{{S}_{1} + {S}_{2} + {S}_{3} + … + {S}_{n}} = 40 W$$

where n is the quantity of heating elements, n is greater than or equal to 2, Sₙ is an area of the heating element, Wₙ is the heating power of the heating element, Pₙ is a rated power of the heating element, Rₙ is a resistance of the heating element. Because the current is 2 A at most when the conventional power bank outputs a voltage of 20 V, i.e., the power is 40 W, it can be guaranteed, according to aforementioned heating logic, that the power output of the power bank at the supply of 20 V is fully utilized while the current may not exceed 2 A.

In some specific implementations, in case that the voltage of the external power source is 9 V, a proportion of a heating duration of a respective heating element to one electricity supplying period is to =(2×Sₙ)/(S₁+S₂ . . . +Sₙ), a heating power of a respective heating element is:

$${W}_{n} = {P}_{n} \times {t}_{n} = {U}^{2} \times \frac{{t}_{n}}{{R}_{n}} = {9}^{2} \times \frac{{t}_{n}}{10} = 8.1 {t}_{n} ,$$

a total heating power of multiple heating elements can be obtained by:

$$\sum w = {W}_{1} + {W}_{2} + {W}_{3} + … + {W}_{n} = 8.1 \times \frac{{S}_{1} + {S}_{2} + {S}_{3} + … + {S}_{n}}{{S}_{1} + {S}_{2} + {S}_{3} + … + {S}_{n}} = 8 \text{.1} W$$

where n is the quantity of heating elements, n is greater than or equal to 2, Sₙ is an area of the heating element, W, is the heating power of the heating element, Pₙ is a rated power of the heating element, Rₙ is a resistance of the heating element. Because the current is 2 A at most when the conventional power bank outputs a voltage of 9 V, i.e., the power is 18 W, it can be guaranteed, according to aforementioned heating logic, that the power output of the power bank at the supply of 20 V is fully utilized while the current may not exceed 2 A.

In some specific implementations, in case that the voltage of the external power source is 5 V, a proportion of a heating duration of a respective heating element to one electricity supplying period is to =1, a heating power of a respective heating element is:

$${W}_{n} = {P}_{n} \times {t}_{n} = {U}^{2} \times \frac{{t}_{n}}{{R}_{n}} = {5}^{2} \times \frac{{t}_{n}}{10} = 2.5 {t}_{n} ;$$

a total heating power of multiple heating elements can be obtained by:

$$\sum w = {W}_{1} + {W}_{2} + {W}_{3} + … + {W}_{n} = 2.5 \times \frac{{S}_{1} + {S}_{2} + {S}_{3} + … + {S}_{n}}{{S}_{1} + {S}_{2} + {S}_{3} + … + {S}_{n}} = 2 \text{.5} n W$$

where n is the quantity of heating elements, n is greater than or equal to 2, Sₙ is an area of the heating element, Wₙ is the heating power of the heating element, Pₙ is a rated power of the heating element, Rₙ is a resistance of the heating element.

Specifically, it needs to be ensured that the total current is to be smaller than the rated current 2A of the power bank when fully utilizing the power bank at high power to generate heat, thereby avoiding damage or other harmful effects on the power bank operated above the rated power. Therefore, the total resistance of the heating element 20, the heating element 30 and the heating element 40 needs to be greater than 10R.

Specifically, it is assumed that an area of the heating element 30 (may be defined as heating pad 2, the same below) is twice as large as each of an area of the heating element 20 (may be defined as heating pad 1, the same below) and an area of the heating element 40 (may be defined as heating pad 3, the same below). To achieve the same heating effect, ½ of the power output by the power bank (namely the external power source, the same below) needs to be applied on the heating pad 2, ¼ of the power needs to be applied on the heating pad 1 and ¼ of the power needs to be applied on the heating pad 3.

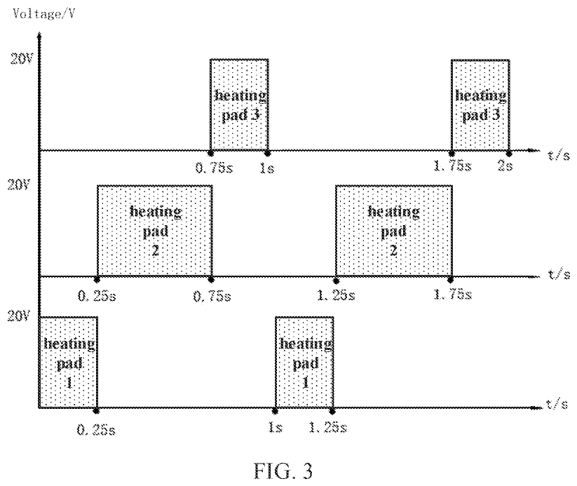

Another embodiment of the present disclosure is described below. Referring to FIG. 3, in case of using a power bank having a rated voltage of 20 V and a rated current of 2 A as an external power source, the power-on logic of the electric heating system capable of adapting to various voltages is as follows: the heating pad 1 generates heat in 0-0.25 s, the heating pad 2 generates heat in 0.25-0.75 s, the heating pad 3 generates heat in 0.75 s-1 s, and the above circulation is repeated. In this way, the 40W rated power of the power bank can be fully utilized without causing overcurrent phenomenon.

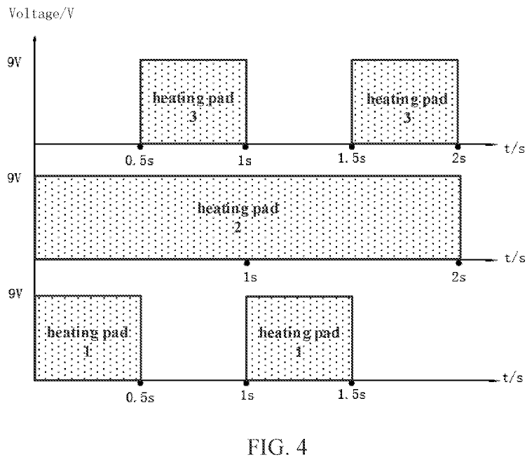

Still another embodiment of the present disclosure is described below. Referring to FIG. 4, in case of using a power bank having a rated voltage of 9 V and a rated current of 2 A as an external power source, the power-on logic of the electric heating system capable of adapting to various voltages is as follows: the heating pad 1 generates heat in 0-0.5 s, the heating pad 2 generates heat in 0-1 s, the heating pad 3 generates heat in 0.5-1 s, and the above circulation is repeated. In this way, the 18 W rated power of the power bank can be fully utilized without causing overcurrent phenomenon.

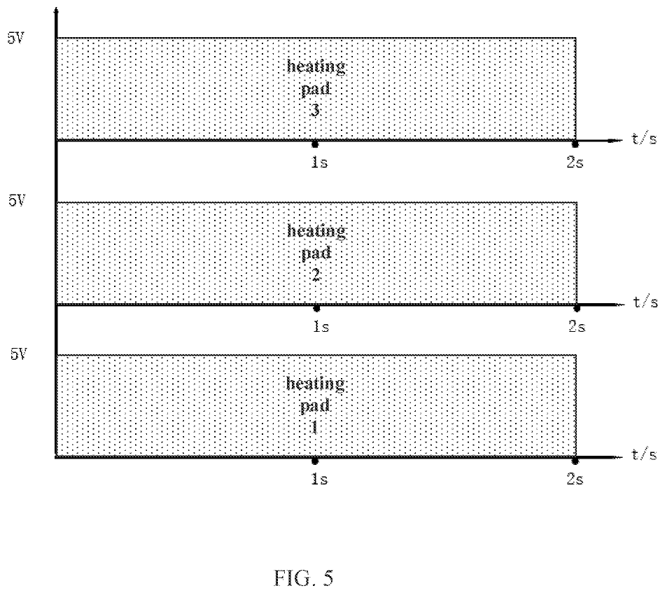

Further another embodiment of the present disclosure is described below. Referring to FIG. 5, in case of using a power bank having a rated voltage of 5 V and a rated current of 2 A as an external power source, since the power density of the heating elements is relatively low under the supply of voltage of 5 V, the heating pads 1, 2, 3 all generate heat at full power. In this way, a total power is 7.5 W, thereby fully utilizing the power supplied by the power bank.

By adopting a specific heating logic, the electric heating system and the heating method capable of adapting to various voltages according to embodiments of the present disclosure are applicable to various types of voltage inputs, and independent temperature control for multiple pads is available.

Furthermore, the specific heating logic of present disclosure enables adaption to all types of external power sources so as to ensure that 10 W, 18 W and 40 W external power sources can all operate at respective rated powers.

In addition, with the specific heating logic provided by the present disclosure, the external power source may not operate above the rated power because of changes in input voltage.

It should be understood that the aforementioned embodiments are only for describing the technical concept and features of the present disclosure, intending to enable those skilled in the art to understand and implement the content of the present disclosure, rather than to limit the protection scope of the present disclosure. Any equivalent changes or modifications made according to the spirit of this disclosure shall all fall within the protection scope of this disclosure.

Industrial Practicality

The present disclosure provides an electric heating system and a heating method capable of adapting to various voltages. The electric heating system includes: multiple heating elements, a controller, a variable-frequency charging element and at least one electric connector. The controller is electrically connected to the multiple heating elements, the multiple heating elements are arranged in parallel. The controller is electrically connected to at least one electric connector via the variable-frequency charging element, which allows the electric connector to connect to power sources with different rated powers and delivers electricity to the multiple heating elements according to preset power-on logic. By adopting a specific heating logic, the electric heating system and the heating method capable of adapting to various voltages according to embodiments of the present disclosure are applicable to various types of voltage inputs, and independent temperature control for multiple pads is available. The specific heating logic of present disclosure enables adaption to all types of external power sources so as to ensure that 10 W, 18 W and 40 W external power sources can all operate at respective rated powers.

In addition, it should be understood that the electric heating system and heating method capable of adapting to various voltages in the present disclosure are reproducible and can be applied in various industrial application. For example, the electric heating system and heating method capable of adapting to various voltages in the present disclosure can be applied to any components needing to be heated.

1-11. (canceled)

12. An electric heating system capable of adapting to various voltages, comprising:
a plurality of heating elements,
a controller, and
at least one electric connector;
wherein the controller is electrically connected to the plurality of heating elements, the plurality of heating elements being arranged in parallel; and
wherein the controller is electrically connected to the at least one electric connector, and in a case that an electric connector in the at least one electric connector is connected to an external power source, the controller enables, according to a preset power-on logic, the external power source to distribute power to the plurality of heating elements, and prevents an output power of the external power source from exceeding a rated power of the external power source.

13. The electric heating system capable of adapting to various voltages according to claim 12, wherein each of the plurality of heating elements is electrically connected to the controller independently, and is able to independently generate heat under control of the controller.

14. The electric heating system capable of adapting to various voltages according to claim 12, wherein at least one of heating temperature or heating time of the plurality of heating elements is identical or different.

15. The electric heating system capable of adapting to various voltages according to claim 12, wherein the controller comprises a fast charge protocol chip, a single-chip microcomputer and a plurality of control circuit modules; the single-chip microcomputer is connected to the fast charge protocol chip and is connected to the plurality of control circuit modules respectively; and the plurality of control circuit modules are connected to the plurality of heating elements respectively.

16. The electric heating system capable of adapting to various voltages according to claim 15, wherein the plurality of control circuit modules are configured to independently control current or voltage outputs of the plurality of heating elements, and the plurality of heating elements are configured to feed temperature back to the single-chip microcontroller.

17. The electric heating system capable of adapting to various voltages according to claim 12, comprising a plurality of heating units, wherein the controller is connected the plurality of heating units respectively, each heating unit comprising one or more heating elements.

18. The electric heating system capable of adapting to various voltages according to claim 12, wherein the heating element comprises an electrothermal film.

19. The electric heating system capable of adapting to various voltages according to claim 12, comprising a plurality of electric connectors which comprise a USB connector.

20. The electric heating system capable of adapting to various voltages according to claim 12, further comprising a plurality of temperature sensors, wherein the plurality of temperature sensors are connected to the plurality of heating elements respectively and are each connected to the controller.

21. The electric heating system capable of adapting to various voltages according to claim 13, wherein at least one of heating temperature or heating time of the plurality of heating elements is identical or different.

22. An electric heating method capable of adapting to various voltages, comprising:
providing an electric heating system capable of adapting to various voltages, wherein the electric heating system capable of adapting to various voltages comprises:
a plurality of heating elements,
a controller, and
at least one electric connector;
wherein the controller is electrically connected to the plurality of heating elements, the plurality of heating elements being arranged in parallel; and
wherein the controller is electrically connected to the at least one electric connector, and in a case that an electric connector in the at least one electric connector is connected to an external power source, the controller enables, according to a preset power-on logic, the external power source to distribute power to the plurality of heating elements, and prevents an output power of the external power source from exceeding a rated power of the external power source;
connecting the electric connector electrically to an external power source; and
supplying electricity and distributing power to the plurality of heating elements according to a preset power-on logic at least based on at least one of an amount of a rated power of the external power source or an area of each heating element, such that each heating element generates heat independently and an output power of the external power source does not exceed the rated power of the external power source.

23. The electric heating method capable of adapting to various voltages according to claim 22, comprising:
successively and periodically supplying electricity to the plurality of heating elements to enable the plurality of heating elements to generate heat periodically, or
simultaneously supplying electricity to the plurality of heating elements to enable the plurality of heating elements to generate heat simultaneously,
wherein electricity is supplied to the plurality of heating elements at identical time or at different time.

24. The electric heating method capable of adapting to various voltages according to claim 23, wherein a sum of currents flowing through the plurality of heating elements does not exceed a rated current of the external power source.

25. The electric heating method capable of adapting to various voltages according to claim 24, wherein the rated current of the external power source is 2 A and a rated voltage of the external power source ranges from 5 V to 20 V.

26. The electric heating method capable of adapting to various voltages according to claim 25, wherein in a case that the voltage of the external power source is 20 V, a proportion of a heating duration of a respective heating element to one electricity supplying period is t, =Sₙ/(S₁+S₂ . . . +Sₙ), a heating power of a respective heating element is:
Wₙ=Pₙ×tₙ=U²×tₙ/Rₙ, where n is the quantity of heating elements, n is greater than or equal to 2, Sₙ is an area of the heating element, Wₙ is the heating power of the heating element, Pₙ is a rated power of the heating element, Rₙ is a resistance of the heating element.

27. The electric heating method capable of adapting to various voltages according to claim 25, wherein in a case that the voltage of the external power source is 9 V, a proportion of a heating duration of a respective heating element to one electricity supplying period is t, =(2×Sₙ)/(S₁+S₂ . . . +Sₙ), a heating power of a respective heating element is:
Wₙ=Pₙ×tₙ=U²×tₙ/Rₙ, where n is the quantity of heating elements and n is greater than or equal to 2, Sₙ is an area of the heating element, Wₙ is the heating power of the heating element, Pₙ is a rated power of the heating element, Rₙ is a resistance of the heating element.

28. The electric heating method capable of adapting to various voltages according to claim 25, wherein in a case that the voltage of the external power source is 5 V, a proportion of a heating duration of a respective heating element to one electricity supplying period is to =1, a heating power of a respective heating element is: Wₙ=Pₙ×tₙ=U²×tₙ/Rₙ, where n is the quantity of heating elements, n is greater than or equal to 2, Sₙ is an area of the heating element, Wₙ is the heating power of the heating element, Pₙ is a rated power of the heating element, Rₙ is a resistance of the heating element.
